(19) United States
(12) Patent Application Publication
(10) Pub. No.: US 2016/0332408 A1
(43) Pub. Date: Nov. 17, 2016

(54) Method of Manufacturing Non-Disassembling Intersecting Partition Matrix

(71) Applicant: Bradford Company, Holland, MI (US)

(72) Inventor: Judson A. Bradford, Holland, MI (US)

(21) Appl. No.: 14/708,751

(22) Filed: May 11, 2015

(51) Int. Cl. B31D 5/00

(52) U.S. Cl. CPC B31D 5/0013

(57) ABSTRACT

A non-collapsible, non-disassembling intersecting partition matrix for insertion into a container divides the space inside the container into individual cells for holding products during shipment. The matrix comprises first slotted partitions intersecting with second slotted partitions. Each of the first slotted partitions has bridges extending upwardly from an intermediate edge of the partition through which one of the second partitions passes to create a preliminary partition matrix. The preliminary partition matrix is heated to melt the bridges of the first slotted partitions. The melted intersections of the matrix are cooled which results in a matrix which may not be disassembled.

### FIELD OF THE INVENTION

The present invention relates to a non-disassembling partition assembly for dividing the space inside a container or box.

### BACKGROUND OF THE INVENTION

In the storage, shipment or display of parts or merchandise, it is a common practice to divide the interior of a box or container into a plurality of individual cells. The interior of a box or container is typically separated by a series of dividers, one set of parallel dividers being orthogonal to a second set of dividers. The dividers separate the interior of the container into a plurality of individual cells, each of which is intended to hold a separate item for display or shipment. The division of the interior of the box or container helps prevent the items therein from contacting one another and breaking during shipping. The division or partitioning of the container also aids in the loading and unloading of the items therein, as well as inventorying the contents of each box or container.

The dividers typically are slotted and arranged in an orthogonal relationship to divide the interior of the box or container into a desired number of cells. The dividers are slotted in a manner that enables the dividers to engage with one another at the location of the slots so that the dividers form an orthogonal grid or matrix. Typically the dividers are made of the same material as the material of the box or container, plastic or paperboard. However, the dividers may be constructed of any suitable material with sufficient rigidity to prevent the contents of the container from contacting one another and being damaged.

Disassembling traditional partition assemblies comprise a series of individual slotted dividers or partitions which mesh together in an orthogonal grid or matrix. The assembly as a whole is generally collapsible, but the individual dividers of the assembly may be removed from the assembly individually and stacked. To disassemble the array or matrix of dividers, one must lift one of the slotted dividers up out of the box or container, disengaging its slots with the slots of the dividers orthogonal to it. Because the assembly is disassembling, the assembly may be stored in much less space than if the assembly were non-disassembling. A problem with this type of partition assembly, though, is that if one desires to re-use the assembly, one has to re-engage the slots of the dividers and then place the assembly inside a box or container. Additionally, this type of partition assembly is subject to inadvertent disassembly whenever parts are removed from the cells of the partition assembly.

A more desirable partition assembly or matrix for many applications is one that is not fully disassembling with the individual dividers of the assembly affixed to each other. Such a non-disassembling partition matrix may be lifted as a whole out of a box or container without the operator worrying about the dividers separating from one another.

Several U.S. patents disclose non-disassembling partition assemblies. However, many of them are still collapsible. Many others require staples, glue or additional plastic material to secure intersecting partitions, which increases the cost of the final partition assembly.

U.S. Pat. No. 5,904,798 discloses a non-disassembling, non-collapsible partition assembly which is made of only the material of the partitions themselves. One disadvantage of the method of making the partition assembly of U.S. Pat. No. 5,904,798 is that the slots of the individual partition assembly must be perfectly aligned before the partitions slots are engaged with each other.

For manufacturing purposes, it would be desirable to manufacture a non-collapsible non-disassembling partition assembly which may be assembled more easily prior to heating the assembly. The present invention enables an operator to put together an intersecting partition assembly more quickly and easily than heretofore before heating the assembly.

### SUMMARY OF THE INVENTION

The non-disassembling intersecting partition assembly of the present invention comprises a plurality of first slotted partitions intersecting with a plurality of second slotted partitions. The slotted partitions are welded together at intersections by parent welds using no material other than that of the partitions themselves. The slotted partitions are preferably made of foamed plastic which melts more easily than other materials and therefore, may be better suited to being parent welded than other materials.

According to one aspect of the present invention, a method of forming a non-disassembling intersecting partition matrix comprises the following steps. The first step comprises providing a plurality of first slotted partitions, each of the first slotted partitions being a first height and providing a plurality of second slotted partitions of a second height different than the first height. The next step comprises engaging slots of the second slotted partitions with slots of the first slotted partitions to form a preliminary matrix in which the partitions are different heights. The next step comprises heating an edge of the preliminary matrix to create a heated matrix in which the partitions have a planar heated edge. The last step comprises cooling the heated matrix to permanently secure the intersecting partitions in a non-disassembling relationship.

According to another aspect of the present invention, a preliminary partition assembly is assembled before being heated and cooled to create the parent welds, thus transforming a preliminary partition assembly, which may be disassembled, into a non-disassembling intersecting partition assembly. Each of the first slotted partitions of this embodiment of preliminary partition assembly has a continuous first non-linear edge comprising a plurality of alternating intermediate edge portions and raised edge portions joined together by diagonal edge portions. Each of the first slotted partitions of the preliminary partition assembly also has a plurality of spaced triangular cut-outs proximate/inside the raised edge portions of the first non-linear edge and a plurality of spaced slots. At least some of the slots of each first slotted partition extend inwardly from the triangular cut-outs towards a second edge of the first slotted partition opposite the first non-linear edge of the first slotted partition. Each raised edge portion of the non-linear first edge of a first slotted partition comprises an upper edge of a bridge located above one of the triangular cut-outs of the first slotted partition.

In one embodiment, the non-collapsible, non-disassembling intersecting partition assembly comprises at least one slotted partition and at least one second slotted partition. However, a collapsible, non-disassembling intersecting partition assembly constructed in accordance with the present invention may comprise any number of slotted partitions.

The method of forming the non-collapsible, non-disassembling intersecting partition assembly comprises engaging the slots of the second slotted partitions with the first slots of the first slotted partitions at intersections to form the preliminary matrix or assembly. The next step comprises inverting or turning over the preliminary partition matrix, which may still be disassembled if desired. The next step comprises heating an edge of the preliminary partition matrix to create a heated matrix. This step may comprise placing an edge of the preliminary partition matrix on a heated surface or proximate a heated surface. During the heating step, the bridges of the preliminary partition matrix are melted. The foamed plastic material of the bridges is melted into the triangular cut-outs and secures the second slotted partition in place at an intersection in a permanent manner with a parent weld after cooling.

The last step comprises cooling the heated matrix to permanently secure the intersecting partitions in a non-collapsible, non-disassembling relationship which may quickly and easily be inserted and/or removed from the interior of a box or container.

The method of forming the non-disassembling intersecting partition matrix may comprise the following steps. The first step may be providing a plurality of first slotted partitions. Each of the first slotted partitions has a plurality of spaced bridges extending above an intermediate edge of the first slotted partition and a triangular cut-out below each of the bridges. A first slot extends inwardly from each triangular cut-out of the first slotted partition towards a second edge of the first slotted partition opposite the intermediate edge of the first slotted partition. The next step may be providing a plurality of second slotted partitions, each of said second slotted partitions having a plurality of slots extending inwardly from a first edge of the second slotted partition towards a second edge of the second slotted partition opposite the first edge of the second slotted partition.

The next step may be engaging the slots of the second slotted partitions with the slots of the first slotted partitions at intersections by passing the second slotted partitions through passages in the bridges of the first slotted partitions to create a preliminary partition matrix.

The next step may be heating the bridges of the first slotted partitions to create a heated matrix for a sufficient time until the bridges melt. This time may be when the intermediate edge portions of the first edge contact the heated surface. The last step may be cooling the heated matrix by removing the heated matrix from the heat source to permanently secure the partitions in a non-disassembling relationship.

In any of the methods disclosed herein the preliminary partition matrix may or may not contact a heated surface. In some methods the preliminary partition matrix may be passed by a heat source, as disclosed in U.S. Pat. No. 5,904,798, which is fully incorporated by reference herein.

### BRIEF DESCRIPTION OF THE DRAWINGS

FIG. 1 is a perspective view of a plurality of first slotted partitions and a plurality of second slotted partitions engaged with each other to form part of a preliminary partition matrix, one of the partitions being disengaged for clarity;

FIG. 2 is a perspective view of the preliminary partition matrix of FIG. 1 after the fully assembled preliminary partition matrix has been inverted, the preliminary partition matrix being lowered to a heated surface;

FIG. 3 is a perspective view of a non-disassembling heated partition matrix after the matrix of FIG. 2 has been heated, the non-disassembling intersecting partition matrix being removed from a heated surface;

FIG. 4 is an enlarged perspective view of a portion of the non-disassembling intersecting partition matrix of FIG. 3 showing some parent welds;

FIG. 5 is a partially disassembled perspective view of an alternative embodiment of preliminary partition matrix prior to being heated;

FIG. 6A is a cross-sectional view of the preliminary partition matrix of FIG. 9 taken along the line 10A-10A of FIG. 9 fully assembled;

FIG. 6B is a side elevational view showing the intersecting partition matrix of FIG. 6A being separated from a heated surface after being heated;

FIG. 7 is an enlarged perspective view of a portion of the non-disassembling intersecting partition matrix of FIG. 6B;

FIG. 8 is a perspective view of a plurality of first and second slotted partitions according to another embodiment before being fully assembled with each other to form a preliminary partition matrix;

FIG. 9 is a perspective view of the preliminary partition matrix of FIG. 8 after it has been fully assembled and inverted and being moved towards a heated surface;

FIG. 10A is a cross-sectional view of the preliminary partition matrix of FIG. 9 taken along the line 10A-10A of FIG. 9;

FIG. 10B is a side elevational view showing a non-disassembling intersecting partition matrix being separated from a heated surface, the intersecting partition matrix resulting from the matrix of FIG. 10A being heated;

FIG. 11 is an enlarged perspective view of a portion of the non-disassembling intersecting partition matrix of FIG. 10B;

FIG. 12 is a perspective view of a plurality of first and second slotted partitions partially engaged with each other to form part of another preliminary partition matrix;

FIG. 13 is a perspective view of a plurality of first and second slotted partitions partially engaged with each other to form part of another preliminary partition matrix;

FIG. 14 is a perspective view of a plurality of first and second slotted partitions partially engaged with each other to form part of another preliminary partition matrix; and

FIG. 15 is a perspective view of a plurality of first and second slotted partitions partially engaged with each other to form part of another preliminary partition matrix.

### DETAILED DESCRIPTION OF THE INVENTION

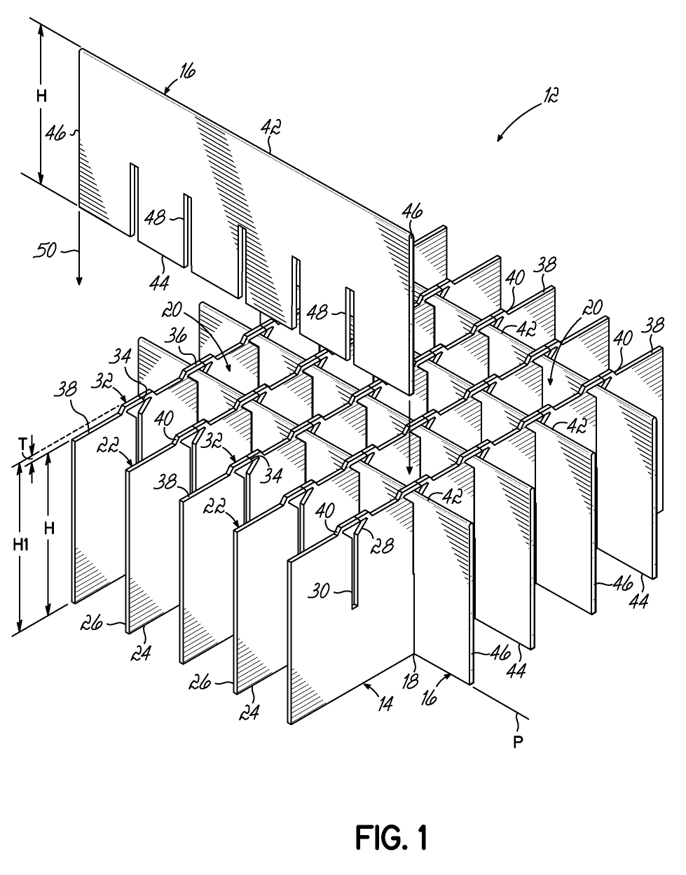

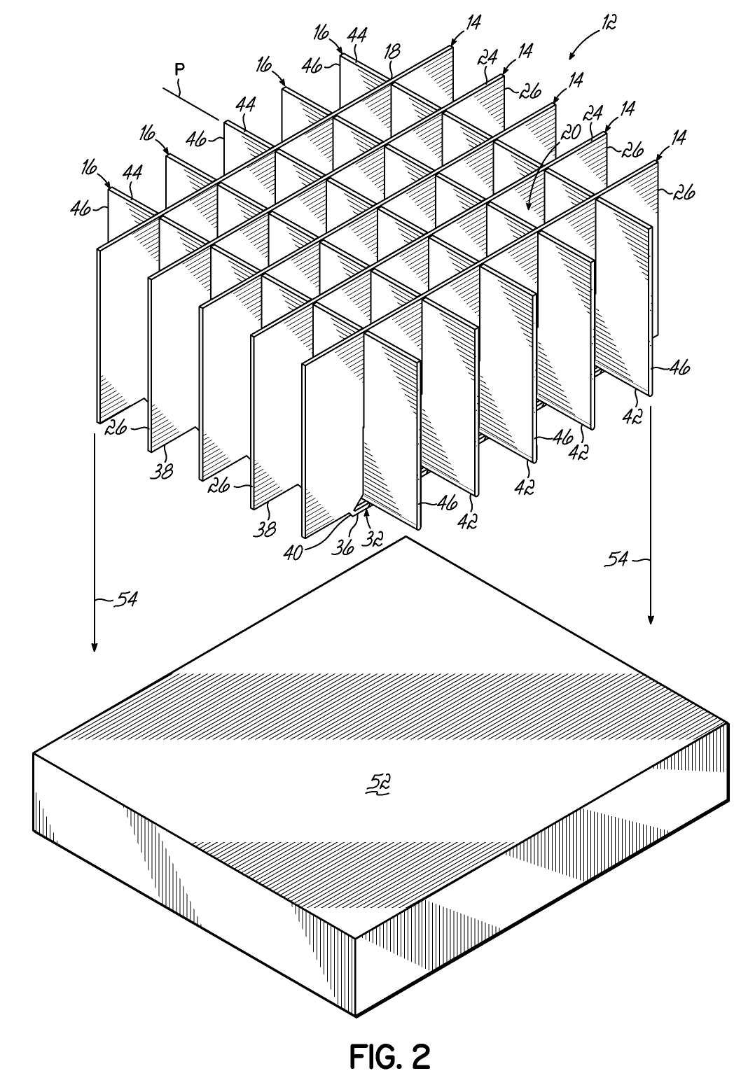

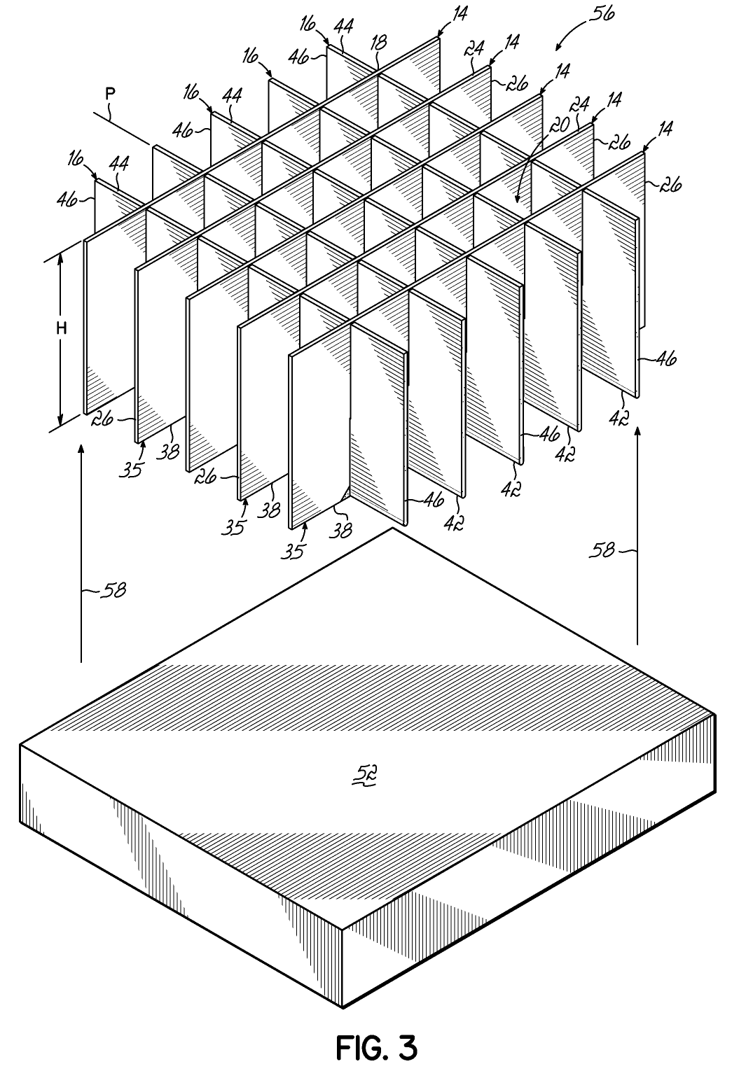

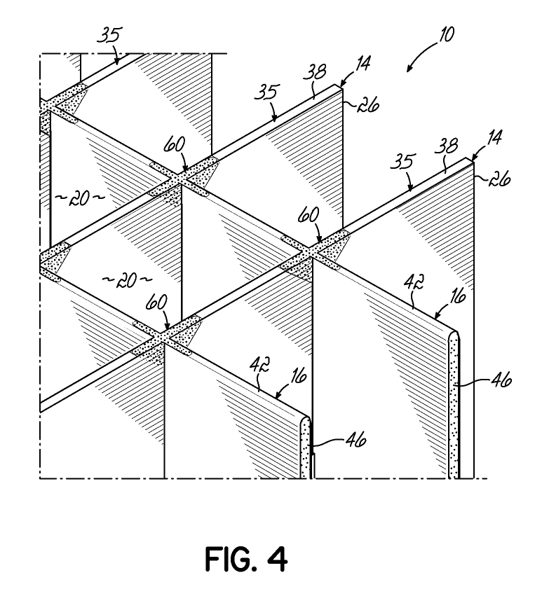

FIG. 4 illustrates a portion of a non-collapsible, non-disassembling intersecting partition matrix or assembly 10 for use in a container or box (not shown). FIGS. 1 and 2 illustrate a preliminary partition matrix 12 which is heated to create a heated partition matrix 56 shown in FIG. 3. The heated partition matrix 56 is then cooled, resulting in the non-collapsible, non-disassembling intersecting partition matrix or assembly 10.

The non-collapsible, non-disassembling intersecting partition matrix 10 comprises a plurality of first slotted partitions 14 and a plurality of second slotted partitions 16 intersecting with the first slotted partitions 12 at intersections 18. See FIG. 2. Although the drawings show the non-collapsible, non-disassembling intersecting partition matrix 10 made with five first slotted partitions 14 and five second slotted partitions 16, any number of either of the partitions 14, 16 may be used in accordance with this invention. As shown in FIG. 1, the illustrated partition matrix 10 defines sixteen individual interior holding cells 20 when fully assembled.

In the drawings, each of the first slotted partitions 14 is identical, one being shown in detail in FIG. 1. Each first slotted partition 14 has a non-linear first edge 22, a linear second opposed edge 24 and a pair of side edges 26. As best shown in FIG. 1, each first slotted partition 14 comprises a plurality of spaced triangular cut-outs 28. Extending inwardly from one corner of each triangular cut-out 28 is a slot 30 (extending towards the second edge 24 of the first partition 14). Although the drawings show each triangular cut-out 28 and each connecting slot 30 being a particular size, the drawings are not intended to be limiting. Each triangular cut-out 28 and associated slot 30 may be any desired size. Above each triangular cut-out 28 is a slotted bridge 32 having a passage 34 extending through the bridge 32. The top or outer edge of each bridge 32 defines a raised edge portion 36 of the non-linear first edge 22 of the first partition 14. A plurality of spaced intermediate linear edge portions 38 located between the raised bridges 32 further define the non-linear first edge 22 of the first partition 14. The upper edge portion 36 above each bridge 32 is joined to intermediate edge portions 38 of the first partition 14 on each side with diagonal edge portions 40. Therefore, the non-linear first edge 22 of each first partition 14 comprises a plurality of intermediate edge portions 38 and a plurality of raised edge portions 36 alternating with each other and joined by a plurality of diagonal edge portions 40. Each passage 34 of each bridge 32 is sized to allow one of the second partitions 16 to pass through it and into one of the triangular cut-outs 28 so the slots 48 of the second slotted partitions 16 may engage the slots 30 of one of the first slotted partitions 14 in a manner described below.

According to the embodiment shown in FIGS. 1-4, each of the second slotted partitions 16 is identical, one of the second slotted partitions 16 being shown in detail in FIG. 1. As seen in FIG. 1, each second slotted partition 16 has a first continuous edge 42, a second opposed edge 44 and a pair of side edges 46. The continuous first edge 42 may be a rounded edge, the partition material being foamed plastic; the partition being known in the industry as SOFTEDGE®. Extending inwardly from the second edge 44 is a plurality of spaced slots 48 (towards the first edge 42). These slots 48 make the second edge 44 non-continuous or interrupted.

The linear distance between the first and second edges 42, 44 of each second slotted partition 16 is a height H, shown in FIG. 1. Similarly, the linear distance between the spaced intermediate linear edge portions 38 of the non-linear first edge 22 and the second opposed edge 24 of each first slotted partition 14 define the same height H. The linear distance between the upper edges of the bridges 32 of the non-linear first edge 22 and the second opposed edge 24 of each first slotted partition 14 define a height H1 greater than the height H. As shown in FIG. 1, the difference between the heights H1 and H define a height or thickness “T” of each of the bridges 32 of each first slotted partition 14. Due to the bridges 32 of the preliminary partition matrix 12 melting into the cut-outs 28 during the heating step and subsequent cooling, the resulting non-collapsible, non-disassembling intersecting partition matrix or assembly 10 has the same height H as the second slotted partitions 16. See FIG. 3. Therefore, as shown in FIG. 3, each of the slotted partitions 14, 16 of the non-collapsible, non-disassembling intersecting partition matrix 10 has the same height H, each of the first slotted partitions 14 being reduced by a height or thickness “T” during the process.

As shown in FIG. 1, in order to make a preliminary partition matrix 12 (which may still be disassembled), each of the slots 48 of one of the second slotted partitions 16 is passed through one of the passages 34 through one of the bridges 32 of one of the first slotted partitions 14 in the direction of arrow 50. The remainder of the second slotted partition 16 is passed through the passages 34 in aligned bridges 32, through aligned triangular cut-outs 28, such that the slots 48 of the second slotted partition 16 engage the slots 30 of the first slotted partitions 14. Each triangular cut-out 28 acts as a guide so the slots 30, 48 of the first and second slotted partitions 14, 16, respectively, do not have to align perfectly during assembly. An assembler or assembly machine may be slightly off and still have the slots 30, 48 engage each other.

As shown in FIG. 1, once fully assembled, the upper edges 42 of the second slotted partitions 16 are located inside the triangular cut-outs 28 of the first slotted partitions 14 in the preliminary partition matrix 12 with the bridges 32 of the first slotted partitions 14 passing over the second slotted partitions 16. Additionally, once the preliminary partition matrix 12 shown in FIG. 1 is fully assembled, the edges 24, 44 of the first and second slotted partitions 14, 16, respectively, are generally planar with each other, located in a plane P.

Any of the first and/or second slotted partitions 14, 16 may be made of foamed plastic, more specifically, a foamed plastic sold by the Bradford Company of Holland, Mich. under the trademark POLYLITE® or SOFTEDGE®.

FIG. 2 illustrates the preliminary partition matrix 12 inverted or rotated from its original position shown in FIG. 1. In other words, the upper edge of the preliminary partition assembly 12 becomes the lower edge of the preliminary partition assembly 12. After the rotation or inversion, the bridges 32 of the first slotted partitions 14 of the preliminary partition matrix 12 are located proximate a heated surface 52. Once fully assembled and oriented with the bridges 32 as shown in FIG. 2, the preliminary partition matrix 12 is lowered in the direction of arrows 54 until the bridges 32 of the preliminary partition matrix 12 rest on the heated surface 52. The bottom surface of the preliminary partition matrix 12 and, more specifically, the bridges 32 of the preliminary partition matrix 12 remain contacting the heated surface 52 for a sufficient length of time until the bridges 32 of the preliminary partition matrix 12 become molten. Heat from the heated surface 52 melts the foamed plastic of the intersecting partitions at the intersections 18, as best shown in FIG. 4, causing the molten material from the bridges 32 to at least partially fill the triangular cut-outs 28.

As shown in FIG. 3, once the bridges 32 of the first slotted partitions 14 of the preliminary partition matrix 12 are melted into the triangular cut-outs 28 of first slotted partitions 14 of the preliminary partition matrix 12 and the heated surface 35 of the heated partition matrix 56 is generally planar, the heated partition matrix 56 is lifted away from the heated surface 52 in the direction of arrows 58. The lower, heated edge 35 of the heated matrix 56 is then allowed to cool to create a plurality of parent welds 60 at the partition intersections, as best shown in FIG. 4. Each parent weld 60 permanently secures intersecting partitions 14, 16 in a non-collapsible, non-disassembling relationship. Each parent weld 60 is formed from the partition material of one of the bridges 32 without the use of any additional material other than the material of the partitions themselves.

As best shown in FIG. 4, after the parent welds 60 are allowed to cool sufficiently, the edges of the first and second slotted partitions 14, 16, respectively, become generally co-planar. In other words, the bridges 32 of the first slotted partitions 14 disappear, the material therein melting or merging into the triangular cut-outs 28 and perhaps into portions of the slots 30 below the triangular cut-outs 28.

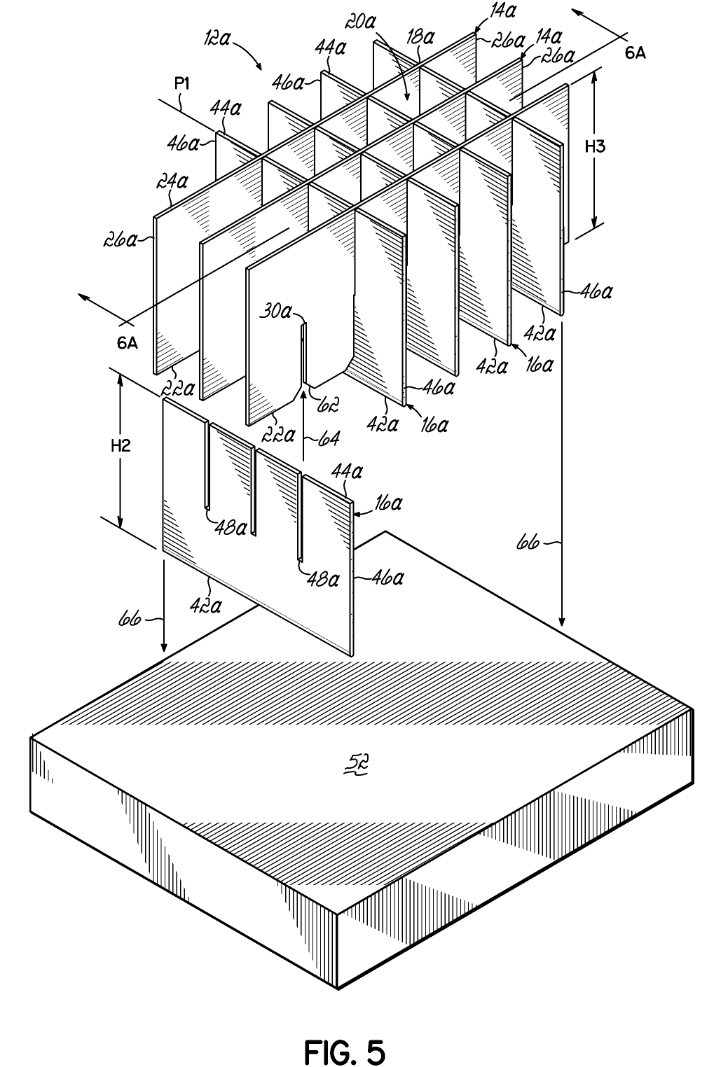

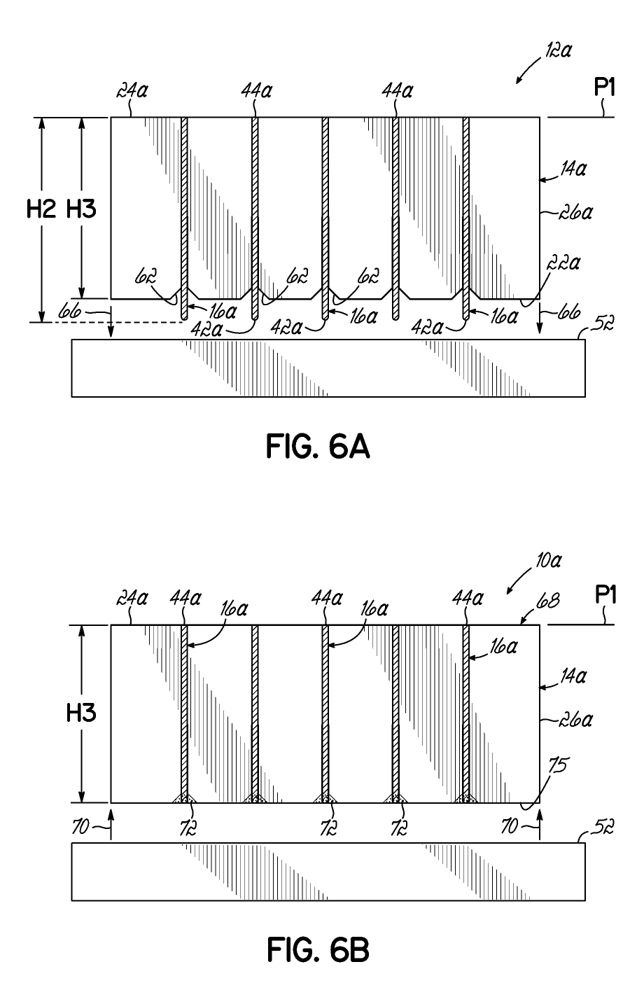

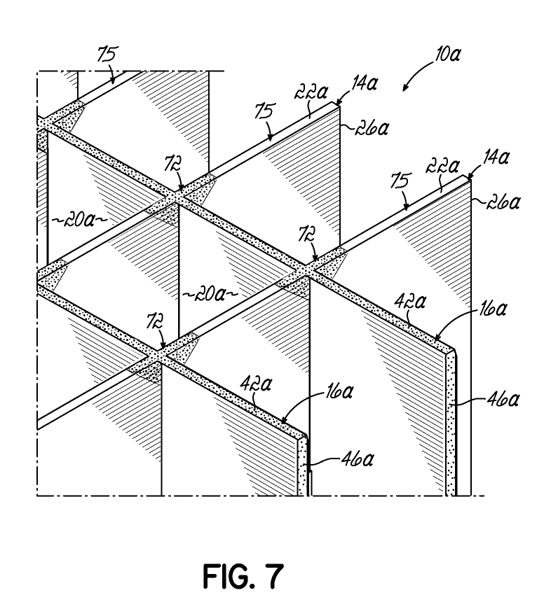

FIGS. 5-7 illustrate another method of making a non-collapsible, non-disassembling intersecting partition matrix or assembly 10a for use in a container or box (not shown). FIGS. 5 and 6A illustrate a preliminary partition assembly 12a which is heated to create a heated partition matrix 68 shown in FIG. 6B. The heated partition matrix 68 is then cooled, resulting in the non-collapsible, non-disassembling intersecting partition matrix 10a partially shown in FIG. 7.

As best shown in FIG. 5, the preliminary slotted partition matrix 12a comprises a plurality of first slotted partitions 14a and a plurality of second slotted partitions 16a intersecting with the first slotted partitions 14a at intersections 18a. Although the drawings show the preliminary intersecting slotted partition matrix 12a made with three first slotted partitions 14a and five second slotted partitions 16a, any number of either of the slotted partitions 14a, 16a may be used in accordance with this invention. As shown in FIG. 5, the illustrated preliminary slotted partition matrix 12a, when placed in a box or container (not shown), defines eight individual interior holding cells 20a when fully assembled.

Each of the first slotted partitions 14a is identical, one being shown in detail in FIG. 5. Each first slotted partition 14a has an interrupted linear first edge 22a, a continuous linear second opposed edge 24a and a pair of side edges 26a. As best shown in FIG. 5, each first slotted partition 14a comprises a plurality of spaced triangular cut-outs or guides 62, each extending inwardly from the first edge 22a. Extending inwardly from one corner of each triangular cut-out 62 is a slot 30a (towards the second edge 24a of the first partition 14a). Although the drawings show each triangular cut-out 62 and each connecting slot 30a being a particular size, the drawings are not intended to be limiting. Each triangular cut-out 62 and associated slot 30a may be any desired size. Each triangular cut-out 62 interrupts the otherwise continuous edge 22a of the first slotted partition 14a. Each triangular cut-out 62 is sized to allow one of the second partitions 16a to pass through it and into one of the slots 30a of one of the first slotted partitions 14a in a manner described below. Each triangular cut-out 62 acts as a guide so the slots of the first and second slotted partitions 14a, 16a do not have to align perfectly during assembly. An assembler or assembly machine may be slightly off and still have the slots 30a, 48a engage each other.

According to the embodiment shown in FIGS. 5-7, each of the second slotted partitions 16a is identical, one of the second slotted partitions 16a being shown in detail in FIG. 5. As seen in FIG. 5, each second slotted partition 16a has a first edge 44a, a second opposed edge 42a, which may be rounded, and a pair of side edges 46a. From the second edge 44a, a plurality of spaced parallel slots 48a extend inwardly (towards the first edge 42a).

The linear distance between the first and second edges 42a, 44a of each second slotted partition 16a is a height H2, shown in FIG. 5. Similarly, the linear distance between the first and second edges 22a, 24a of each first partition 14a defines a different height H3. The height H2 of each of the second slotted partitions 16a is greater than the height H3 of each of the first slotted partitions 14a. Due to the melting of the edges 42a of the second slotted partitions 16a of the preliminary partition matrix 12 during the heating step and subsequent cooling step, the resulting non-collapsible, non-disassembling intersecting partition matrix or assembly 10a has the same height H3 as the height of each of the first slotted partitions 14a. See FIG. 6B.

As shown in FIG. 5, in order to make the preliminary partition matrix 12a (which may still be disassembled), each of the slots 48a of one of the second slotted partitions 16a is raised in the direction of arrow 64. The slots 48a of the second slotted partitions 16a are engaged with or contact the triangular cut-outs 62 of the first slotted partitions 14a, such that the slots 48a of the second slotted partition 16a are guided into the slots 30a of the first slotted partitions 14a. As shown in FIG. 5, once fully assembled, the continuous first edges 42a of the second slotted partitions 16a are located below the first edges 22a of the first slotted partitions 14a in the preliminary partition matrix 12a due to the height differential between the first and second slotted partitions 14a, 16a. See FIG. 6A. Additionally, once the preliminary partition matrix 12a shown in FIG. 5 is fully assembled, the edges 24a, 44a of the first and second slotted partitions 14a, 16a, respectively, are generally planar with each other, located in a plane P1.

Any of the first and/or second slotted partitions 14a, 16a may be made of foamed plastic, more specifically, a foamed plastic sold by the Bradford Company of Holland, Mich. under the trademark POLYLITE® or SOFTEDGE®.

FIG. 6A illustrates the fully assembled preliminary partition matrix 12a. The first edges 42a of the second slotted partitions 16a of the preliminary partition matrix 12a are located proximate a heated surface 52. Once fully assembled and oriented with the partitions 14a, 16a, as shown in FIG. 6A, the preliminary partition matrix 12a is lowered in the direction of arrows 66 until the first edges 42a of the second slotted partitions 16a of the preliminary partition matrix 12a rest on the heated surface 52. The bottom surface of the preliminary partition matrix 12a and, more specifically, the first edges 42a of the second slotted partitions 16a of the preliminary partition matrix 12a remain contacting the heated surface 52 for a sufficient length of time until the first edges 42a of the second slotted partitions 16a of the preliminary partition matrix 12a become molten and melt into the triangular cut-outs 62 of the first slotted partitions 14a. The heat melts the foamed plastic along the first edges 42a of the second slotted partitions 16a of the preliminary partition matrix 12a, as best shown in FIG. 6B.

As shown in FIG. 6B, once the height of each of the second slotted partitions 16a of the preliminary partition matrix 12a is reduced to the same height H3 as the height H3 of the first slotted partitions 14a of the preliminary partition matrix 12a, the heated matrix 68 is lifted away from the heated surface 52 in the direction of arrows 70. The lower edge 75 of the heated matrix 68 is then allowed to cool to create a plurality of parent welds 72 at the partition intersections, as best shown in FIG. 7. Each parent weld 72 permanently secures intersecting partitions 14a, 16a in a non-collapsible, non-disassembling relationship. Each parent weld 72 is formed without the use of any additional material other than the material of the partitions themselves. As shown in FIG. 7, along the lower edge 75 of the non-collapsible, non-disassembling partition matrix 10a, the edges 22a, 42a of the first and second slotted partitions 14a, 16a, respectively, are generally co-planar, due to the melting of the second slotted partitions 16a.

As best shown in FIG. 7, after the parent welds 72 are allowed to cool sufficiently, the edges of the first and second slotted partitions 14a, 16a, respectively, become generally co-planar. In other words, the height differential between the first and second slotted partitions 14 disappears, the material of the taller second slotted partitions 16a therein melting and/or merging into the triangular cut-outs 62 of the shorter first slotted partitions 14a and perhaps into a portion of the slots 30a above the triangular cut-outs 62.

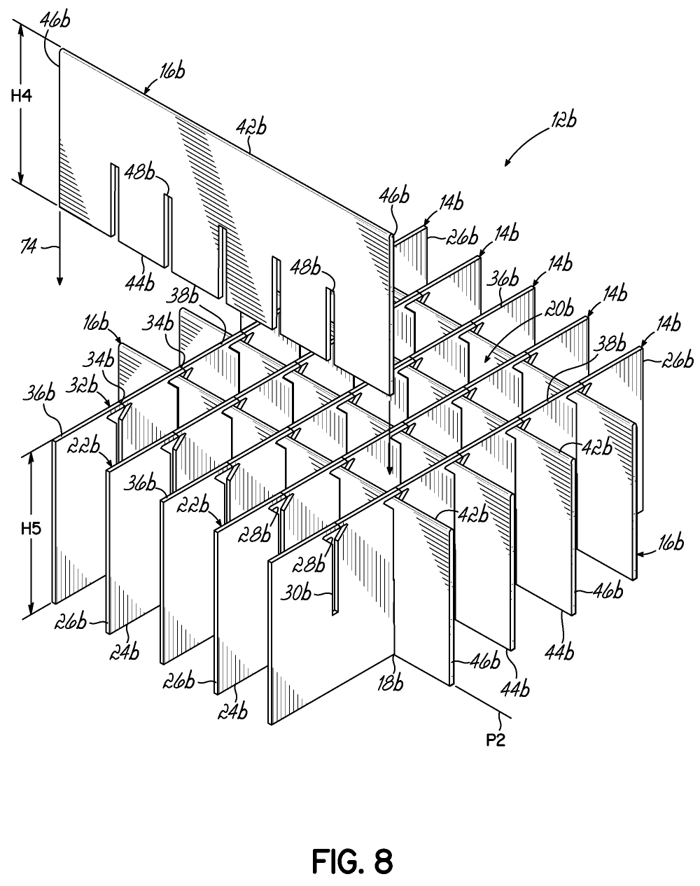

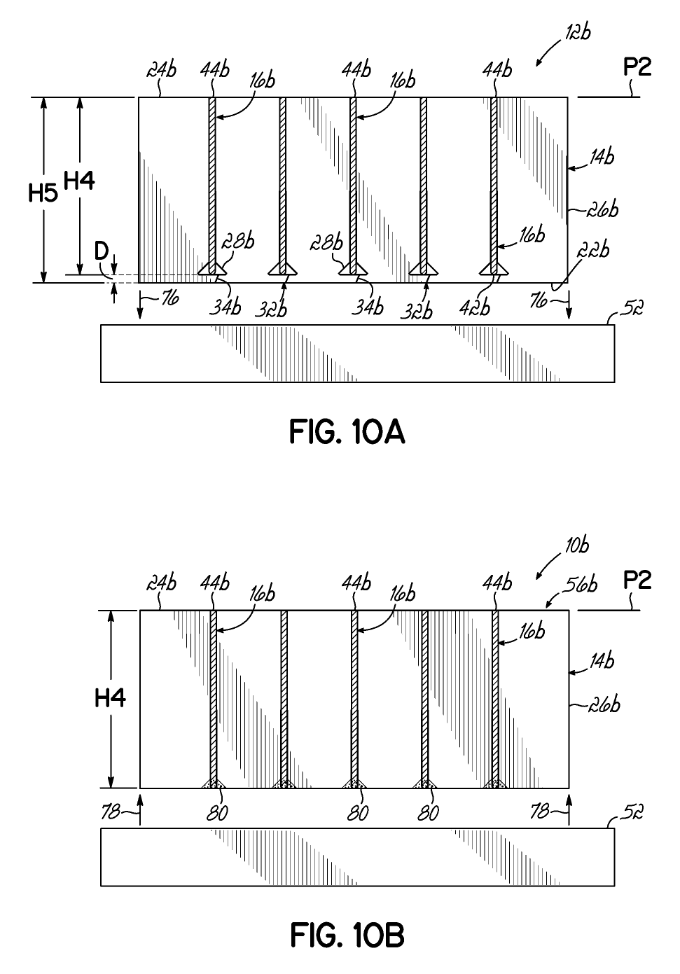

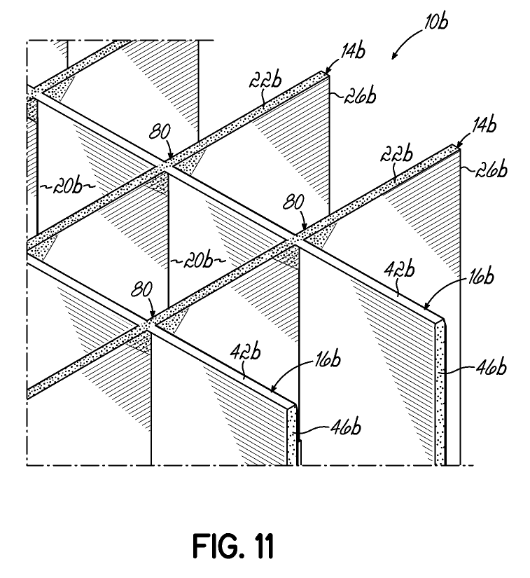

FIGS. 8-11 illustrate another method of making a non-collapsible, non-disassembling intersecting partition matrix or assembly 10b for use in a container or box (not shown). FIGS. 8, 9 and 10A illustrate a preliminary partition assembly 12b which is heated to create a heated partition matrix 56B shown in FIG. 10B. The heated partition matrix 56B is then cooled, resulting in the non-collapsible, non-disassembling intersecting partition matrix 10b partially shown in FIG. 11.

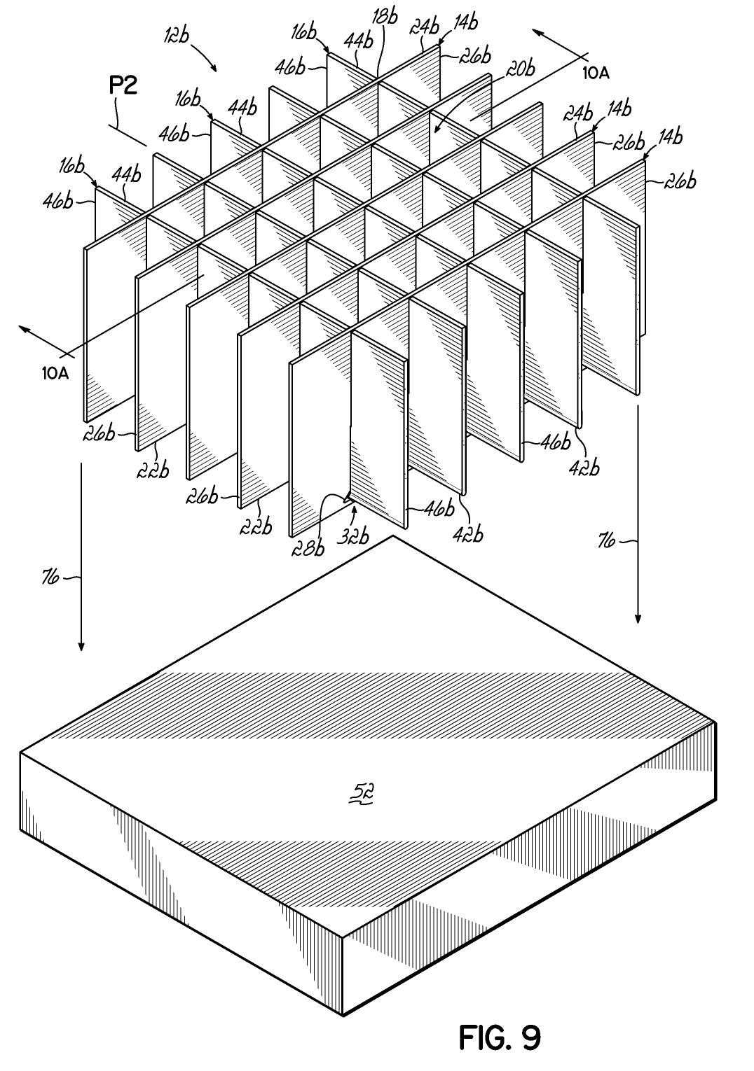

The non-collapsible, non-disassembling intersecting partition matrix 10b comprises a plurality of first slotted partitions 14b and a plurality of second slotted partitions 16b intersecting with the first slotted partitions 14b at intersections 18b. See FIG. 9. Although the drawings show the non-collapsible, non-disassembling intersecting partition matrix 10b made with five first slotted partitions 14b and five second slotted partitions 16b, any number of either of the partitions 14b, 16b may be used in accordance with this invention. As shown in FIG. 9, the illustrated partition matrix 10b defines sixteen interior individual holding cells 20b when fully assembled.

Each of the first slotted partitions 14b is identical, one being shown in detail in FIG. 8. Each first slotted partition 14b has a linear first edge 22b, a linear second opposed edge 24b and a pair of side edges 26b. As best shown in FIG. 8, each first slotted partition 14b comprises a plurality of spaced triangular cut-outs 28b. Extending inwardly from one corner of each triangular cut-out 28b is a slot 30b (towards the second edge 24b of the first partition 14b). Although the drawings show each triangular cut-out 28b and each connecting slot 30b being a particular size, the drawings are not intended to be limiting. Each triangular cut-out 28b and associated slot 30b may be any desired size. Above each triangular cut-out 28b is a slotted bridge 32b having a passage 34b extending through the bridge 32b. The outer edge of each bridge 32b is part of the linear first edge 22b of the first partition 14b. A plurality of spaced intermediate linear edge portions 38b located between the bridges 32b further define the linear first edge 22b of the first partition 14b. Therefore, the linear first edge 22b of each first partition 14b comprises a plurality of intermediate edge portions 38b and a plurality of raised edge portions 36b alternating with each other. Each passage 34b of each bridge 32b is sized to allow one of the second partitions 16b to pass through it and into one of the triangular cut-outs 28b so it can eventually engage one of the slots 30b of one of the first slotted partitions 14b in a manner described below.

According to the embodiment shown in FIGS. 8-11, each of the second slotted partitions 16b is identical, one of the second slotted partitions 16b being shown in detail in FIG. 8. As seen in FIG. 8, each second slotted partition 16b has a first continuous edge 42b, a second opposed edge 44b and a pair of side edges 46b. The continuous first edge 42b may be a rounded edge made from material known in the industry as SOFTEDGE®. Extending inwardly from the second edge 44b is a plurality of spaced slots 48b (towards the first edge 42b). These slots 48b make the second edge 44b non-continuous or interrupted.

The linear distance between the first and second edges 42b, 44b of each second slotted partition 16b is a height H4, shown in FIG. 8. Similarly, the linear distance between the spaced intermediate linear edge portions 38 of the linear first edge 22b and the second opposed edge 24b of each first partition 14b defines a height H5, greater than the height H4 of the second slotted partitions H5. Due to the melting process of the bridges 32b of the preliminary partition matrix 12b during the heating step and subsequent cooling step, the resulting non-collapsible, non-disassembling intersecting partition matrix or assembly 10b has the same height H4 as the second slotted partitions 16b of the preliminary partition matrix 12b. See FIG. 10B.

As shown in FIG. 8, in order to make a preliminary partition matrix 12b which may still be disassembled, each of the slots 48b of one of the second slotted partitions 16b is passed through one of the bridges 32b of one of the first slotted partitions 14b in the direction of arrow 74. The remainder of the second slotted partition 16b is passed through the passages 34b in the bridges 32b, through the triangular cut-outs 28b, such that the slots 48b of the second slotted partition 16b engage the slots 30b of the first slotted partitions 14b. As shown in FIG. 8, once fully assembled, the upper edges 42b of the second slotted partitions 16b are located inside the triangular cut-outs 28b of the first slotted partitions 14b in the preliminary partition matrix 12b with the bridges 32b of the first slotted partitions 14b passing over the second slotted partitions 16b. Additionally, once the preliminary partition matrix 12b shown in FIG. 8 is fully assembled, the edges 24b, 44b of the first and second slotted partitions 14b, 16b, respectively, are generally planar with each other, located in a plane P2. However, the edges 22b, 42b of the first and second slotted partitions 14b, 16b, respectively, are not generally planar with each other. As shown in FIG. 9, the edges 22b of the first slotted partitions 14b are below the edges 42b of the second slotted partitions 16b when the preliminary partition matrix 12b is placed on the heated surface 52 to parent weld the partitions together.

Any of the first and/or second slotted partitions 14b, 16b may be made of foamed plastic, more specifically, a foamed plastic sold by the Bradford Company of Holland, Mich. under the trademark POLYLITE® or SOFTEDGE®.

FIG. 9 illustrates the preliminary partition matrix 12b inverted or rotated from its original position shown in FIG. 8. In other words, the upper edges of the preliminary partition assembly 12b are now the lower edges of the preliminary partition assembly 12b. After the rotation or inversion, the bridges 32b of the first slotted partitions 14b of the preliminary partition matrix 12b are located proximate a heated surface 52. Once fully assembled and oriented with the bridges 32b as shown in FIG. 9, the preliminary partition matrix 12b is lowered in the direction of arrows 76 until the bridges 32b of the preliminary partition matrix 12b rest on the heated surface 52. The bottom surface of the preliminary partition matrix 12b and, more specifically, the edges 22b of the first slotted partitions 14b of the preliminary partition matrix 12b, remain contacting the heated surface 52 for a sufficient length of time until the edges 22b of the first slotted partitions 14b of the preliminary partition matrix 12b become molten. The heat melts the foamed plastic of the first slotted partitions 14b of the preliminary partition matrix 12b until the height of the first slotted partitions 14b of the preliminary partition matrix 12b is reduced a distance D, as best shown in FIG. 10A.

As shown in FIG. 10B, once the first slotted partitions 14b of the preliminary partition matrix 12b are melted or reduced in height a distance D and fill the triangular cut-outs 28b of first slotted partitions 14b of the preliminary partition matrix 12b, the heated matrix 56b is lifted away from the heated surface 52 in the direction of arrows 78. The lower edge of the heated matrix 56b is then allowed to cool to create a plurality of parent welds 80 at the partition intersections, as best shown in FIG. 11. Each parent weld 80 permanently secures intersecting partitions 14b, 16b in a non-collapsible, non-disassembling relationship. The parent weld is formed without the use of any additional material other than the material of the partitions themselves.

As best shown in FIG. 11, after the parent welds 80 are allowed to cool sufficiently, the edges of the first and second slotted partitions 14b, 16b, respectively, become generally co-planar. In other words, the bridges 32b of the first slotted partitions 14b disappear, the material therein melting or merging into the triangular cut-outs 28b and perhaps into a portion of the slots 30b below the triangular cut-outs 28b.

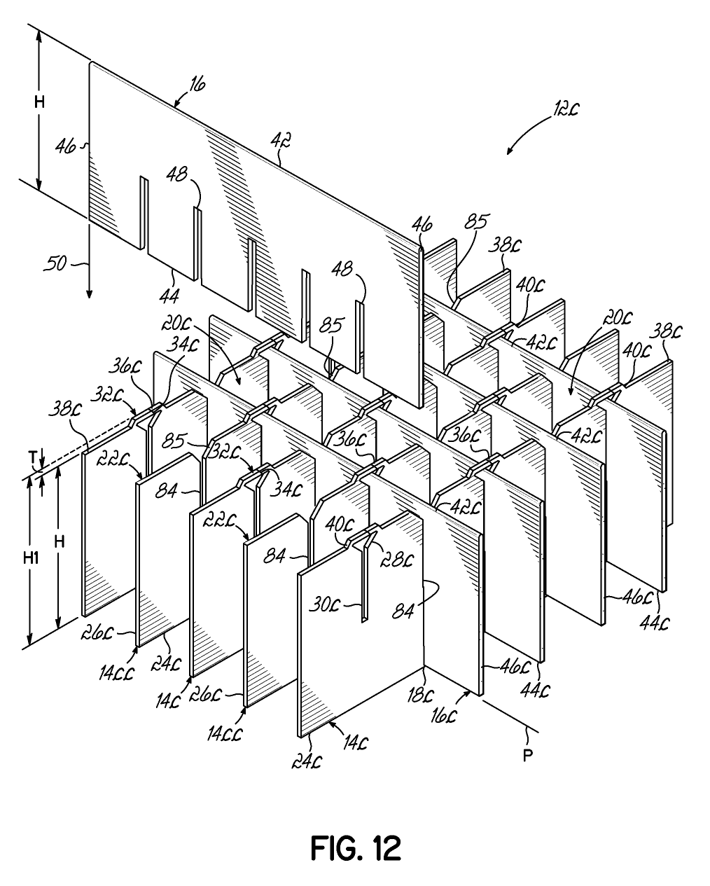

FIGS. 12-15 illustrate the concept that not every intersection need be parent welded, regardless of the embodiment used to create a partition matrix. FIG. 12 illustrates a partially-disassembled preliminary partition matrix 12c comprising a plurality of first slotted partitions 14c, 14cc (which are similar but not identical) and a plurality of second slotted partitions 16 which are all identical. Each second slotted partition 16 is identical to those used in the preliminary slotted partition matrix 12 shown in FIG. 1. However, each of the first slotted partitions 14c, 14cc is slightly different than the first slotted partitions 14 of the preliminary slotted partition matrix 12 shown in FIG. 1. In the embodiment illustrated in FIG. 12 two different configurations of first slotted partitions 14c, 14cc are arranged in alternating fashion. However, any number of different configurations of first slotted partitions may be used.

Although the drawings show the preliminary partition matrix 12c made with five first slotted partitions 14c, 14cc and five second slotted partitions 16, any number of any of these partitions may be used in accordance with this invention. As shown in FIG. 12, the illustrated preliminary partition matrix 12c defines sixteen individual interior holding cells 20c when fully assembled.

As shown in FIG. 12, each first slotted partition 14c, 14cc has a non-linear first edge 22c, a linear second opposed edge 24c and a pair of side edges 26c. As best shown in FIG. 12, each first slotted partition 14c comprises a plurality of spaced triangular cut-outs 28c. Extending inwardly from one corner of each triangular cut-out 28c is a slot 30c (extending towards the second edge 24c of the first partition 14c). Although the drawings show each triangular cut-out 28c and each connecting slot 30c being a particular size, the drawings are not intended to be limiting. Each triangular cut-out 28c and associated slot 30c may be any desired size. Above each triangular cut-out 28c is a slotted bridge 32c having a passage 34c extending through the bridge 32c. The top or outer edge of each bridge 32c defines a raised edge portion 36c of the non-linear first edge 22c of the first slotted partition 14c, 14cc. A plurality of spaced intermediate linear edge portions 38c located between the raised bridge portions 32c further define the non-linear first edge 22c of the first slotted partition. The raised portion 36c above each bridge 32c is joined to intermediate edge portions 38c of the first partition 14c, 14cc on each side with diagonal edge portions 40c. Therefore, the non-linear first edge 22c of each first partition 14c, 14cc comprises a plurality of intermediate edge portions 38c and a plurality of raised edge portions 36c alternating with each other and joined by a plurality of diagonal edge portions 40c. Each passage 34c of each bridge 32c is sized to allow one of the second partitions 16 to pass through it and into one of the triangular cut-outs 28c so the slots 48 of the second slotted partitions 16 may engage the slots 30c of one of the first slotted partitions 14c, 14cc in a manner described below. Although the drawings show every other slot 84 extending directly inwardly from a V-shaped guide 85 extending inwardly from an intermediate edge portion 38c, the drawings are not intended to be limiting. For example, every third or fourth slot may extend directly inwardly from a V-shaped guide extending inwardly from an intermediate edge portion of each first slotted partition or every slot except the outmost slots may extend directly inwardly from a V-shaped guide extending inwardly from an intermediate edge portion of each first slotted partition.

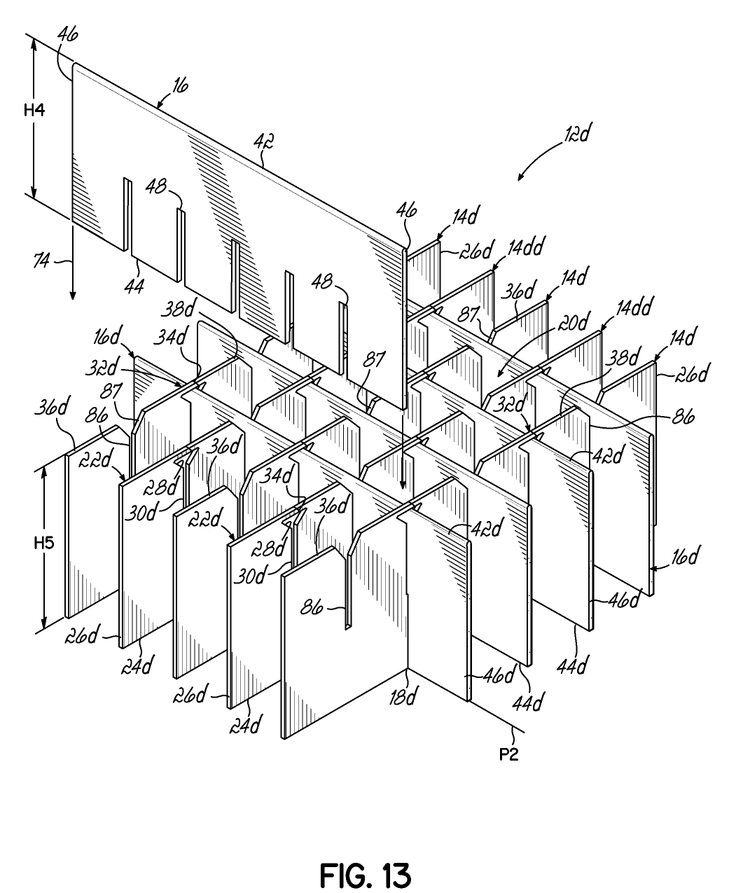

FIG. 13 illustrates a partially-disassembled preliminary partition matrix 12d comprising a plurality of first slotted partitions 14d, 14dd (which are similar but not identical) and a plurality of second slotted partitions 16 which are all identical. Each second slotted partition 16 is identical to those used in the preliminary slotted partition matrix 12b shown in FIG. 8. However, each first slotted partition 14d, 14dd is slightly different than the first slotted partitions 14b of the preliminary slotted partition matrix 12b shown in FIG. 8. In the embodiment illustrated in FIG. 13 two different configurations of first slotted partitions 14d, 14dd are arranged in alternating fashion. However, any number of different configurations of first slotted partitions may be used.

As shown in FIG. 13, each of the first slotted partitions 14d, 14dd has a linear first edge 22d, a linear second opposed edge 24d and a pair of side edges 26d. As best shown in FIG. 13, each first slotted partition 14d, 14dd comprises a plurality of spaced triangular cut-outs 28d. Extending inwardly from one corner of each triangular cut-out 28d is a slot 30d (towards the second edge 24d of the first partition 14d). Although the drawings show each triangular cut-out 28d and each connecting slot 30d being a particular size, the drawings are not intended to be limiting. Each triangular cut-out 28d and associated slot 30d may be any desired size. Above each triangular cut-out 28d is a slotted bridge 32d having a passage 34d extending through the bridge 32d. The outer edge of each bridge 32d is part of the linear first edge 22d of the first partition 14d. A plurality of spaced intermediate linear edge portions 38d located between the bridges 32d further define the linear first edge 22d of the first partition 14d. Therefore, the linear first edge 22d of each first partition 14d, 14dd comprises a plurality of intermediate edge portions 38d and a plurality of raised edge portions 36d alternating with each other. Each passage 34d of each bridge 32d is sized to allow one of the second partitions 16b to pass through it and into one of the triangular cut-outs 28d so it can eventually engage one of the slots 30d of one of the first slotted partitions 14d, 14dd in a manner described below.

As shown in FIG. 13, each first slotted partition 14d, 14dd has every other slot 86 extending directly inwardly from a V-shaped guide 87 extending inwardly the linear first edge 22d. The other slots 30d each extend inwardly from a triangular cutout 28d located below a slotted bridge 32d, as described herein. Although the drawings show every other slot 86 extending directly inwardly from a V-shaped guide 87 extending inwardly from the linear first edge 22d, the drawings are not intended to be limiting. For example, every third or fourth slot may extend directly inwardly from a V-shaped guide extending inwardly from an intermediate edge of each first slotted partition or every slot except the outmost slots may extend directly inwardly from a V-shaped guide extending inwardly from the linear first edge 22d of each first slotted partition.

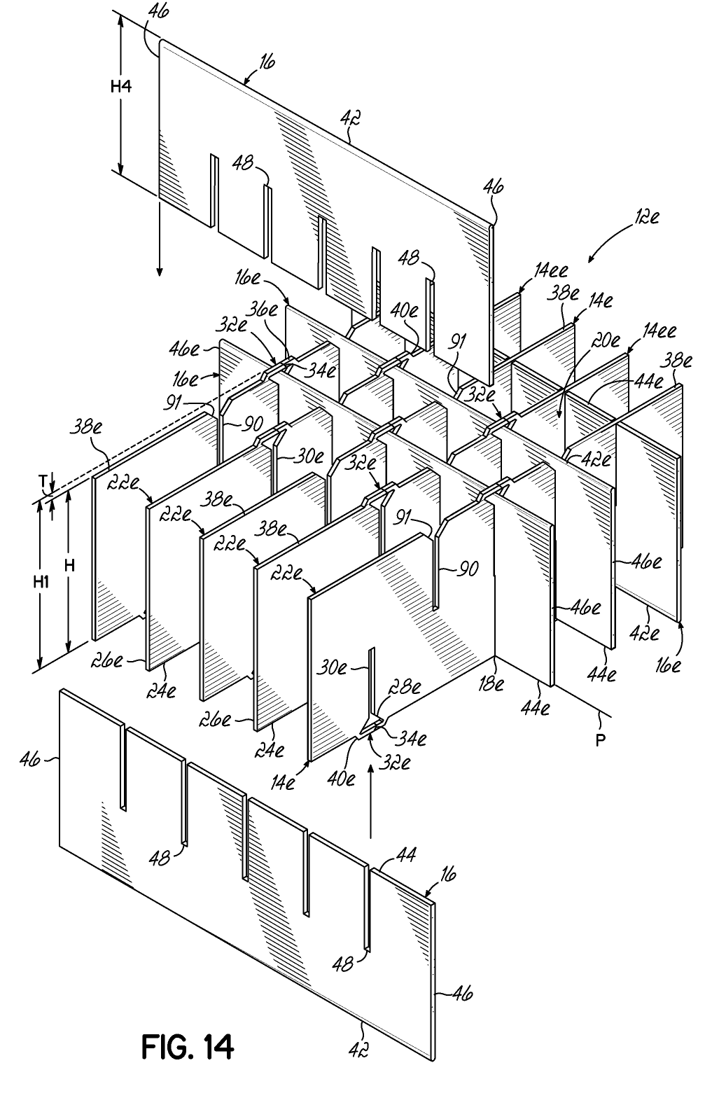

FIG. 14 illustrates a partially-disassembled preliminary partition matrix 12e comprising a plurality of first slotted partitions 14e, 14ee and a plurality of second slotted partitions 16. Each second slotted partition 16 is similar to second slotted partitions 16a used in the preliminary slotted partition matrix 12a shown in FIG. 5. According to the embodiment shown in FIG. 14, each of the second slotted partitions 16 is identical, one of the second slotted partitions 16 being shown in detail in FIG. 14. As seen in FIG. 14, each second slotted partition 16 has a first linear edge 44, a second opposed linear edge 42 which may be rounded and a pair of side edges 46. From the second edge 44, a plurality of spaced parallel slots 48 extend inwardly (towards the first edge 42).

As shown in FIG. 14, each first slotted partition 14e, 14ee is slightly different than the first slotted partitions 14 of the preliminary slotted partition matrix 12 shown in FIG. 1. As shown in FIG. 14, each first slotted partition 14e, 14ee has opposed non-linear first and second edges 22e, 24e and a pair of side edges 26e. Each non-linear edge 22e, 24e comprises a plurality of intermediate edge portions 38e and a plurality of raised edge portions 36e joined by a plurality of diagonal edge portions 40e. As shown in FIG. 14, in each first slotted partition 14e every other slot 90 extends directly inwardly from a V-shaped guide 91 extending inwardly from an intermediate edge portion 38e along one of the non-linear edges 22e, 24e. The other slots 30e each extend inwardly from a triangular cutout 28e located adjacent a slotted bridge 32e, as described herein. Although the drawings show every other slot 90 extending inwardly from a V-shaped guide 91 extending inwardly from an intermediate edge portion 38e, the drawings are not intended to be limiting. For example, every third or fourth slot may extend directly inwardly from a V-shaped guide 91 extending inwardly from an intermediate edge of each first slotted partition or every slot except the outmost slots may extend directly inwardly from a V-shaped guide 91 extending inwardly from an intermediate edge portion of each first slotted partition.

In order to full manufacture the preliminary partition matrix 12e into a non-dissembling dissembling partition matrix, each of the upper and lower edges containing bridges would have to be heated until the bridges melt. This would require flipping the preliminary partition matrix 12e after one of the upper and lower edges was sufficiently heated to create parent welds on one side.

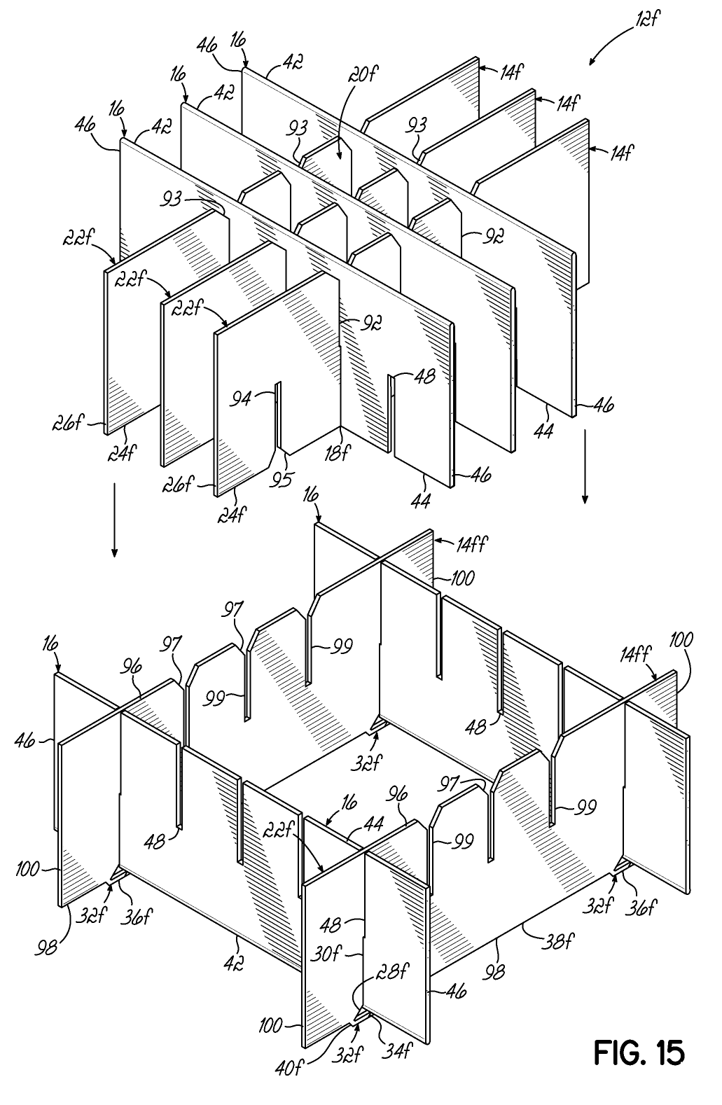

FIG. 15 illustrates a partially-disassembled preliminary partition matrix 12f comprising a plurality of first slotted partitions 14f, 14ff and a plurality of second slotted partitions 16. Each second slotted partition 16 is identical to the second slotted partitions 16 used in the preliminary slotted partition matrix 12 shown in FIG. 1 with slots 48 extending inwardly from an edge 44. However, in this embodiment the two outside or perimeter slotted partitions 16 are turned upside down compared to the interior second slotted partitions 16 (which are all oriented identically) so the slots 48 extend downwardly as shown in FIG. 15, as opposed to upwardly as they do in the interior second slotted partitions 16. As seen in FIG. 15, regardless of how the partition is oriented, each second slotted partition 16 has a first linear edge 44, a second opposed linear edge 42 which may be rounded and a pair of side edges 46. From the second edge 44, a plurality of spaced parallel slots 48 extend inwardly (towards the first edge 42).

As shown in FIG. 15, first slotted partitions 14f, 14ff are different from each other. Each first slotted partition 14f is similar to, but different than, each first slotted partition 14e of the preliminary slotted partition matrix 12e shown in FIG. 14. Each first slotted partition 14f has no bridges. As shown in FIG. 15, each first slotted partition 14ff does have two bridges 32f, each bridge 32f having a passage 34f. As shown in FIG. 15, each first slotted partition 14f has opposed linear first and second edges 22f, 24f and a pair of side edges 26f. Each first slotted partition 14f has a plurality of spaced interior slots 92 each extending directly inwardly from a V-shaped guide 93 extending inwardly from edge22f. Each first slotted partition 14f also has two outermost or end slots 94 each extending directly inwardly from a V-shaped guide 95 extending inwardly from edge 24f of slotted partition 12f.

As shown in FIG. 15, each first slotted partition 14ff has opposed first and second edges 96, 98 and a pair of side edges 100. Each first edge 96 is generally linear but has a plurality of V-shaped guides 97 extending inwardly therefrom. A linear slot 99 extends inwardly from each of the V-shaped guides 97. The second edge 98 of slotted partition 14ff is generally non-linear and comprises a plurality of intermediate edge portions 38f and a plurality of raised edge portions 36f joined by a plurality of diagonal edge portions 40f. When heated the bridges 32f of the partitions 14ff melt in a manner described herein to create four parent welds at the corner intersections.

While I have described only a few embodiments of my invention, I do not intend to be limited except by the scope of the following claims.

What is claimed is:

1. A method of forming a non-disassembling intersecting partition matrix, said method comprising:
providing a plurality of first slotted partitions, each of said second slotted partitions being a first height;
providing a plurality of second slotted partitions of a second height different than the first height;
engaging slots of the second slotted partitions with slots of the first slotted partitions to form a preliminary matrix in which the partitions are different heights;
heating an edge of the preliminary matrix to create a heated matrix in which the partitions have a planar heated edge; and
cooling the heated matrix to permanently secure the intersecting partitions in a non-disassembling relationship.

2. The method of claim 1 wherein heating the edge of the preliminary matrix comprises placing the preliminary matrix on a heated surface.

3. The method of claim 1 wherein heating the edge of the preliminary matrix comprises melting portions of the preliminary matrix.

4. The method of claim 1 wherein heating the edge of the preliminary matrix comprises melting portions of the first partitions of the preliminary matrix.

5. The method of claim 1 wherein heating the edge of the preliminary matrix comprises melting bridge portions of the first partitions of the preliminary matrix.

6. The method of claim 1 wherein at least some of the partitions are made at least partially of foam.

7. A method of forming a non-disassembling intersecting partition matrix, said method comprising:
providing a plurality of first slotted partitions, each of the first slotted partitions having a plurality of spaced bridges extending above an intermediate edge of the first slotted partition and a cut-out below each of the bridges and a first slot extending inwardly from each cut-out of the first slotted partition towards a second edge of said first slotted partition opposite said intermediate edge of said first slotted partition,
providing a plurality of second slotted partitions, each of said second slotted partitions having a plurality of slots extending inwardly from a first edge of the second slotted partition towards a second edge of said second slotted partition opposite said first edge of said second slotted partition,
engaging said slots of said second slotted partitions with said slots of said first slotted partitions at intersections by passing the second slotted partitions through passages in the bridges of the first slotted partitions to create a preliminary partition matrix, the second edges of the second slotted partitions residing in the cut-outs;
heating the bridges of the first slotted partitions to create a heated matrix; and
cooling the heated matrix to permanently secure the partitions in a non-disassembling relationship.

8. The method of claim 7 wherein heating the bridges of the first slotted partitions comprises placing the preliminary matrix on a heated surface.

9. The method of claim 7 wherein heating the bridges of the first slotted partitions comprises placing the bridges of the first slotted partitions on a heated surface.

10. The method of claim 7 wherein heating the bridges of the first slotted partitions comprises melting the bridges of the first slotted partitions.

11. The method of claim 10 wherein heating the bridges of the first slotted partitions comprises melting the bridges of the first slotted partitions and portions of the second slotted partitions.

12. A method of forming a non-disassembling intersecting partition matrix, said method comprising:
providing a plurality of first slotted plastic partitions, each of the first slotted partitions having a plurality of spaced bridges extending above an intermediate edge of the first slotted partition and a triangular cut-out below each of the bridges and a slot extending inwardly from each triangular cut-out of the first slotted partition towards a second edge of said first slotted partition opposite said intermediate edge of said first slotted partition,
providing a plurality of second slotted plastic partitions, each of said second slotted partitions having a plurality of slots extending inwardly from a first edge of the second slotted partition towards a second edge of said second slotted partition opposite said first edge of said second slotted partition,
passing said second slotted partitions through passages in the bridges of said first slotted partitions to create an intersecting preliminary partition matrix;
heating the bridges of the first slotted partitions to create a heated matrix; and
cooling the heated matrix to permanently secure the partitions in a non-disassembling relationship.

13. The method of claim 12 wherein heating the bridges of the first slotted partitions comprises placing the preliminary matrix on a heated surface.

14. The method of claim 12 wherein heating the bridges of the first slotted partitions comprises placing the bridges of the first slotted partitions on a heated surface.

15. The method of claim 12 wherein heating the bridges of the first slotted partitions comprises melting the bridges of the first slotted partitions.

16. The method of claim 12 wherein heating the bridges of the first slotted partitions comprises melting the bridges of the first slotted partitions and portions of the second slotted partitions.

17. The method of claim 16 wherein each of said bridges of said first slotted partitions are melted at intersections of the preliminary partition matrix.
